(19) United States
(12) Patent Application Publication
(10) Pub. No.: US 2015/0155562 A1
(43) Pub. Date: Jun. 4, 2015

(54) NEGATIVE ACTIVE MATERIAL FOR RECHARGEABLE LITHIUM BATTERY, METHOD OF PREPARING SAME, AND RECHARGEABLE LITHIUM BATTERY INCLUDING SAME

(71) Applicant: Samsung SDl Co., Ltd., Yongin-si (KR)

(72) Inventors: Jae-Hwan HA, Yongin-si (KR); Jin-Uk LEE, Yongin-si (KR); Ki-Jun KIM, Yongin-si (KR); Cheol-Hee HWANG, Yongin-si (KR)

(21) Appl. No.: 14/534,015

(22) Filed: Nov. 5, 2014

(30) Foreign Application Priority Data
Dec. 4, 2013 (KR) 10-2013-0150186

(51) Int. Cl. H01M 4/62; H01M 4/1395; H01M 10/052; H01M 4/48; H01M 4/36; H01M 4/04

(52) U.S. Cl. CPC H01M 4/62; H01M 4/366; H01M 4/0402; H01M 4/0423; H01M 4/0428; H01M 4/0426; H01M 10/052; H01M 4/483; H01M 4/1395

(57) ABSTRACT

A method of preparing a negative active material for a rechargeable lithium battery including preparing a powder including a silicon-carbon composite or a Si-based material represented by SiOₓ wherein 0≦x<2; and introducing a transition metal-containing material including a transition metal or a transition metal oxide catalyst, in a form of an island, on the surface of the powder is disclosed. In addition, a rechargeable lithium battery including the negative active material is also disclosed.

### CROSS-REFERENCE TO RELATED APPLICATIONS

Any and all priority claims identified in the Application Data Sheet, or any correction thereto, are hereby incorporated by reference under 37 CFR 1.57. For example, this application claims the benefit of Korean Patent Application No. 10-2013-0150186 filed in the Korean Intellectual Property Office on Dec. 4, 2013, the disclosures of which are incorporated herein by reference in their entirety.

### BACKGROUND

1. Field

The present disclosure relates to a negative active material for a rechargeable lithium battery, methods of preparing the same, and a rechargeable lithium battery including the same.

2. Description of the Related Technology

Batteries generate electric power using electrochemical reaction materials for the positive and negative electrodes. For example, the lithium rechargeable batteries generate electrical energy from changes of chemical potential during the intercalation/deintercalation of lithium ions at the positive and negative electrodes.

Lithium rechargeable batteries use positive and negative active materials that reversibly intercalate or deintercalate lithium ions during charge and discharge reactions. The lithium rechargeable batteries also contain an organic electrolyte or a polymer electrolyte between the positive electrode and the negative electrode.

Composite metal oxides such as LiCoO₂, LiMn₂O₄, LiNiO₂, LiNi₁₋ₓCoₓO₂ (0<x<1), LiMnO₂, and the like have been researched to be used as a positive active material in the rechargeable lithium battery.

For the negative active material used in the rechargeable lithium battery, various carbon-based materials such as artificial graphite, natural graphite, and hard carbon, which can intercalate and deintercalate lithium ions, have been used. Among the carbon-based materials, graphite has a low discharge potential of −0.2V relative to lithium, the battery using graphite as a negative active material has a high discharge potential of about 3.6 V and also excellent energy density. Furthermore, use of graphite guarantees a long battery cycle life due to its outstanding reversibility. However, graphite active material has a low density of about 1.6 g/cc and consequently was a low capacity in terms of energy density per unit volume when the graphite is used as a negative active material.

In order to overcome the problem, a carbon-based material coated with silica has been recently used. However, since lithium ions react with oxygen of silica to form a lithium oxide during the charge and discharge cycle and the generation of the lithium oxide is an irreversible reaction, thus the carbon-based material coated with the silica deteriorates the capacity of a rechargeable lithium battery.

### SUMMARY OF CERTAIN INVENTIVE ASPECTS

One aspect of the present disclosure relates to a method of preparing a negative active material for a rechargeable lithium battery having excellent capacity characteristics by using a transition metal or transition metal oxide catalyst to change the reaction of producing a lithium oxide into a reversible reaction.

Another aspect provides a negative active material for a rechargeable lithium battery including a core comprising a Si-based material; and a transition metal-containing material including a transition metal or transition metal oxide and coated in the form of an island on the surface of the core, in which the transition metal-containing material coated in the form of an island converts the reaction of producing a lithium oxide from an irreversible into a reversible reaction and improves the capacity characteristics of a rechargeable lithium battery.

An additional aspect provides a rechargeable lithium battery including the negative active material prepared according to the method described herein.

One aspect of the disclosed technology relates to a method of preparing a negative active material for a rechargeable lithium battery that includes preparing a powder including a silicon-carbon composite or a Si-based material represented by Chemical Formula 1:

SiOₓ [Chemical Formula 1];

and introducing a transition metal-containing material including a transition metal or a transition metal oxide catalyst, in a form of an island, on the surface of the powder.

In the above Chemical Formula 1, 0≦x<2.

The transition metal may be selected from the group consisting of gold (Au), silver (Ag), platinum (Pt), cobalt (Co), manganese (Mn), nickel (Ni), vanadium (V), iron (Fe), copper (Cu), scandium (Sc), zirconium (Zr), niobium (Nb), chromium (Cr), molybdenum (Mo), or a combination thereof.

The transition metal-containing material may have an average particle diameter in the range of about 0.5 nm to about 20 nm.

The transition metal-containing material may have an average particle diameter in the range of about 0.5 nm to about 10 nm.

The transition metal-containing material may be included in an amount of about 1 to about 100 parts by weight based on 100 parts by weight of the Si-based material, or 100 parts by weight of the silicon-carbon composite.

The Si-based material may have an average particle diameter in the range of about 0.5 nm to about 100 nm.

The process of introducing the transition metal-containing material in a form of an island, on the surface of the powder including the Si-based material or the silicon-carbon composite may be performed using a physical vapor deposition method, a chemical vapor deposition method, a thermal deposition method, an electron beam evaporation method, a sputtering method, or a combination thereof.

Another embodiment provides a negative active material for a rechargeable lithium battery that includes a core including a silicon-carbon composite or a Si-based material represented by Chemical Formula 1:

SiOₓ [Chemical Formula 1];

and a transition metal-containing material, in a form of an island, on the surface of the core.

In the above Chemical Formula 1, 0≦x<2.

The transition metal-containing material may be represented by the following Chemical Formula 2 or 3;

M_{y}O_{z} [Chemical Formula 2]

M [Chemical Formula 3].

In the above Chemical Formulae 2 and 3, M is a metal including gold (Au), silver (Ag), platinum (Pt), cobalt (Co), manganese (Mn), nickel (Ni), vanadium (V), iron (Fe), copper (Cu), scandium (Sc), zirconium (Zr), niobium (Nb), chromium (Cr), molybdenum (Mo), or a combination thereof, wherein 0<y<5, and wherein 0<z<20.

The transition metal-containing material may have an average particle diameter in the range of about 0.5 nm to about 20 nm.

The transition metal-containing material may have an average particle diameter in the range of about 0.5 nm to about 10 nm.

The transition metal-containing material may be included in an amount of about 1 part by weight to about 100 parts by weight based on 100 parts by weight of the Si-based material or 100 parts by weight of the silicon-carbon composite.

The Si-based material may have an average particle diameter in the range of about 0.5 nm to about 100 nm.

Yet another aspect of the disclosed technology provides a rechargeable lithium battery that includes a negative electrode including a negative active material prepared according to the method of preparing a negative active material for a rechargeable lithium battery; a positive electrode including a positive active material; and an electrolyte.

Other embodiments are included in the following detailed description.

According to one embodiment, the method of preparing a negative active material for a rechargeable lithium battery uses a transition metal or transition metal oxide catalyst and may improve capacity and cycle life characteristics of a rechargeable lithium battery. In addition, the negative active material for a rechargeable lithium battery according to another embodiment includes a transition metal-containing material and thus, may improve capacity and cycle life characteristics of a rechargeable lithium battery.

### BRIEF DESCRIPTION OF THE DRAWINGS

FIG. 1 is a schematic view showing a rechargeable lithium battery.

FIG. 2 is a graph showing cycle-life characteristics of rechargeable lithium battery cells according to Example 1 and Comparative Example 1.

FIG. 3 is a graph showing capacity efficiency of the rechargeable lithium battery cells according to Example 1 and Comparative Example 1.

### DETAILED DESCRIPTION OF CERTAIN INVENTIVE EMBODIMENTS

Hereinafter, embodiments of the present invention are described in detail. However, these embodiments are exemplary, and this disclosure is not limited thereto.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

In some embodiments, the method of manufacturing the negative active material for a rechargeable lithium battery includes preparing a powder including a silicon-carbon composite or a Si-based material represented by the following Chemical Formula 1;

SiOₓ Chemical Formula 1

and introducing a transition metal-containing material including a transition metal or a transition metal oxide catalyst, in the form of an island, on the surface of the powder.

In the above Chemical Formula 1, 0≦x<2. In some embodiments, 1.04≦x≦1.06.

The step of introducing a transition metal-containing material including a transition metal or a transition metal oxide catalyst in the form of an island on the surface of the powder may be performed by depositing the transition metal-containing material in the form of an island on the surface of the powder.

In some embodiments, the silicon-carbon (Si—C) composite may include a simple mixture of silicon and carbon, a compound obtained by physically bonding silicon with carbon, a compound obtained by coating carbon on the surface of silicon, a compound obtained by coating silicon on the surface of carbon, and the like.

In general, the Si-based material is used as a negative active material for a rechargeable lithium battery, and an oxygen atom in the Si-based material, for example, silica and the like reacts with a lithium ion and forms a lithium oxide during charge and discharge. The reaction of producing the lithium oxide is irreversible and thus, plays a role of decreasing capacity and cycle life of the rechargeable lithium battery.

However, the method of preparing a negative active material for a rechargeable lithium battery reduces the lithium oxide by using a transition metal or transition metal oxide as shown in a reversible reaction of the following Reaction Scheme 1 and thus, may increase capacity and cycle life characteristics of the rechargeable lithium battery. The following Reaction Scheme 2 is an example of using manganese as a transition metal (M) in Reaction Scheme 1.

LiOₓ+M [symbol] MOₓ+Li Reaction Scheme 1

In Reaction Scheme 1, M is a transition metal.

LiO₂+Mn [symbol] MnO₂+Li Reaction Scheme 2

In addition, a Si-based material in general has a volume expansion as the cycle repeats and thus, deteriorates cycle life characteristics of a battery, but the transition metal or transition metal oxide is coated on the surface of the Si-based material and thus, may suppress the volume expansion of the Si-based material.

Furthermore, the transition metal or transition metal oxide works as a catalyst for the lithium oxide reduction reaction and ultimately may solve a conventional irreversible problem during the charge and discharge.

In some embodiments, the transition metal may be gold (Au), silver (Ag), platinum (Pt), cobalt (Co), manganese (Mn), nickel (Ni), vanadium (V), iron (Fe), copper (Cu), scandium (Sc), zirconium (Zr), niobium (Nb), chromium (Cr), molybdenum (Mo), or a combination thereof.

The transition metal-containing material may include transition metal or transition metal oxide.

In some embodiments, the transition metal-containing material may have an average particle diameter in the range of about 0.5 nm to about 20 nm. For example, the transition metal-containing material may have an average particle diameter in the range of about 0.5 nm to about 10 nm. When the average particle diameter of the transition metal-containing material is within the range, the charge and discharge cycle life characteristic may be increased.

On the other hand, when the transition metal-containing material has an average particle diameter of less than about 0.5 nm or greater than about 20 nm, an irreversible phenomenon occurs and may not reduce a lithium oxide.

The transition metal-containing material may be included in an amount of about 1 part to about 100 parts by weight based on 100 parts by weight of the Si-based material or 100 parts by weight of the silicon-carbon composite. When the transition metal-containing material is used in an amount of less than about 1 part by weight based on 100 parts by weight of the Si-based material, the lithium oxide is not reduced and may deteriorate capacity of the rechargeable lithium battery; when the transition metal-containing material is included in an amount of greater than about 100 parts by weight based on 100 parts by weight of the Si-based material or 100 parts by weight of the silicon-carbon composite, the output characteristic of the battery of the deteriorates due to conductivity deterioration. In addition, the volume expansion Si-based material is not presented resulting in cracks on the surface, and thus, resulting in the transition metal coated on the surface of the Si-based material peeling off as the battery cycle repeats. In addition, as a non-reaction material is included in a higher ratio in the entire weight, the battery capacity may suffer overall deterioration. In other words, since an active material is decreased as the transition metal-containing material which plays the role of a catalyst is increased, nominal capacity is decreased as the transition metal-containing material is increased.

The Si-based material may have an average particle diameter in the range of about 0.5 nm to about 100 nm. When the Si-based material has an average particle diameter within the range, the Si-based material is less likely to crack due to volume expansion during charge and discharge and this may increase battery capacity characteristics. In addition, the Si-based material has an increased surface area reacting with lithium ions and thus may increase high power characteristics.

The silicon-carbon (Si—C) composite may have an average particle diameter in the range of about 10 nm to about 10 μm.

First of all, the powder including a silicon-carbon composite or a Si-based material represented by the above Chemical Formula 1 is prepared, and a transition metal-containing material including a transition metal or transition metal oxide catalyst is introduced in the form of an island, for example, by depositing it on the surface of the powder.

The introduction, by deposition may include, for example, a physical vapor deposition method, a chemical vapor deposition method, a thermal deposition method, an electron beam evaporation method, a sputtering method, or a combination thereof but is not limited thereto.

In addition, the transition metal-containing material including a transition metal or transition metal oxide catalyst is not present in the form of a layer covering the whole surface of the powder but in the form of an island. When the transition metal-containing material is present in the form of a layer, that is, completely covers the surface of the powder, it may hinder intercalation/deintercalation of lithium ions into the core and thus, deteriorate output characteristics of a battery.

In some embodiments, the method of preparing a negative active material for a rechargeable lithium battery may further include washing the powder including a Si-based material deposited with a transition metal-containing material.

The washing may be performed by dipping the powder including a Si-based material or the silicon-carbon composite deposited with a transition metal-containing material in a solution including water, alcohol, acetone, or a combination thereof. The washing may occur one or more times by changing the solution and also include filtrating and drying between washings during a plurality of washings. The drying may be performed at a temperature in the range of about 100° C. to about 250° C. under a vacuum but is not limited thereto.

In some embodiments, the negative active material for a rechargeable lithium battery includes a core including a silicon-carbon composite or the Si-based material represented by the above Chemical Formula 1; and a transition metal-containing material, in the form of an island, on the surface of the core.

The transition metal-containing material may be represented by the following Chemical Formula 2 or 3.

M_{y}O_{z} Chemical Formula 2

M Chemical Formula 3

In the above Chemical Formulae 2 and 3, M is a metal including gold (Au), silver (Ag), platinum (Pt), cobalt (Co), manganese (Mn), nickel (Ni), vanadium (V), iron (Fe), copper (Cu), scandium (Sc), zirconium (Zr), niobium (Nb), chromium (Cr), molybdenum (Mo), or a combination thereof, wherein 0<y<5, and 0<z<20.

The transition metal-containing material and Si-based material are the same as described above.

The negative active material for a rechargeable lithium battery may be usefully applied to a negative electrode for an electrochemical cell such as a rechargeable lithium battery. The rechargeable lithium battery includes a positive electrode including a positive active material and an electrolyte along with a negative electrode including the negative active material.

In some embodiments, the negative electrode may be manufactured by mixing the negative active material for a rechargeable lithium battery, a conductive material, a binder, and a solvent to prepare a negative active material composition, directly coating the negative active material composition on a copper current collector, and drying it.

The conductive material may be carbon black, graphite, or a metal powder, and the binder may be a vinylidene fluoride/hexafluoropropylene copolymer, polyvinylidene fluoride, polyacrylonitrile, polymethylmethacrylate, polytetrafluoroethylene, and a mixture thereof, but not limited thereto. The solvent may be N-methylpyrrolidone, acetone, tetrahydrofuran, decane, and the like, but is not limited thereto. Herein, the negative active material, the conductive material, the binder, and the solvent may be used in an amount conventionally used in a rechargeable lithium battery.

The positive electrode may be manufactured by mixing a positive active material, a binder, and a solvent to prepare a positive active material composition and then, coating the positive active material composition on an aluminum current collector. Herein, the positive active material composition may further include a conductive material if necessary.

The positive active material may include a material intercalating and deintercalating lithium, for example, metal oxide, composite lithium metal oxide, composite lithium metal sulfide, composite lithium metal nitride, and the like but is not limited thereto. Specifically, at least one composite oxide of lithium and a metal of cobalt, manganese, nickel, or a combination thereof may be used, and specific examples thereof may be a compound represented by one of the following chemical formulae. LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiₐE_{2-b}R_{b}O_{4-c}D_{c} (0.90≦a≦1.8, 0≦b≦0.5, 0≦c≦0.05); LiₐNi_{1-b-c}Co_{b}R_{c}D_{α} (0.90≦a≦1.8, 0≦b≦0.5, 0≦c≦0.05 and 0<α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

In some embodiments, the positive active material may include the positive active material with the coating layer, or a compound of the active material and the active material coated with the coating layer. The coating layer may include a coating element compound of an oxide of a coating element, hydroxide of a coating element, oxyhydroxide of a coating element, oxycarbonate of a coating element, or hydroxycarbonate of a coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any conventional processes as long as it does not causes any detrimental side effects on the properties of the positive active material (e.g., spray coating, immersing), which is well known to persons having ordinary skill in this art, so a detailed description thereof is omitted.

The separator may be any generally-used separator for a rechargeable lithium battery, and specific examples may include but are not limited to polyethylene, polypropylene, polyvinylidene fluoride or a multi-layer of two or more, and may be a mixed layer of a polyethylene/polypropylene double-layered separator, a polyethylene/polypropylene/polyethylene triple-layered separator, a polypropylene/polyethylene/polypropylene triple-layered separator, and the like.

The electrolyte filled for a rechargeable lithium battery may include a non-aqueous electrolyte, a solid electrolyte, or the like, in which a lithium salt is dissolved.

The solvent for a non-aqueous electrolyte includes cyclic carbonates such as ethylene carbonate, diethylene carbonates, propylene carbonate, butylene carbonate, vinylene carbonate and the like, linear carbonate such as dimethyl carbonate, ethylmethyl carbonate, diethyl carbonate and the like, esters such as methyl acetate, ethyl acetate, propyl acetate, methyl propionate, ethyl propionate, γ-butyrolactone and the like, ethers such as 1,2-dimethoxyethane, 1,2-diethoxyethane, tetrahydrofuran, 1,2-dioxane, 2-methyltetrahydrofuran and the like, nitriles, acetonitrile, and the like, amides such as dimethylformamide and the like, but is not limited thereto. The solvent may be used singularly or in combination of two or more. In particular, the solvent may be a mixed solvent of a cyclic carbonate and a linear carbonate.

The electrolyte may include a gel-type polymer electrolyte prepared by impregnating an electrolyte solution in a polymer electrolyte such as polyethylene oxide, polyacrylonitrile, and the like, or an inorganic solid electrolyte such as LiI and Li₃N, but is not limited thereto.

The lithium salt includes at least one salt selected from LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlO₂, LiAlCl₄, LiCl, and LiI, but is not limited thereto.

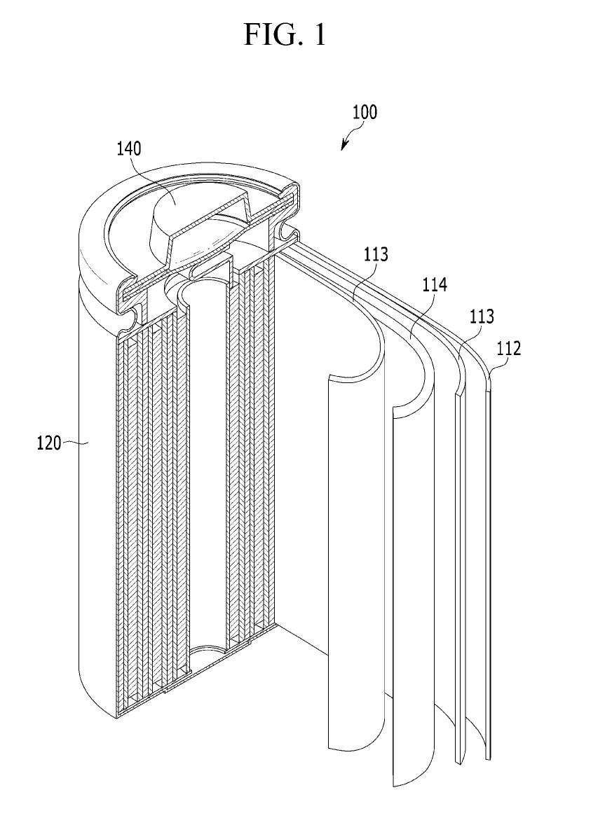

FIG. 1 is a schematic view of a rechargeable lithium battery.

Referring to FIG. 1, the rechargeable lithium battery 100 is a cylindrical battery that includes a negative electrode 112, a positive electrode 114, a separator 113 interposed between the negative electrode 112 and positive electrode 114, and an electrolyte (not shown) impregnating the negative electrode 112, the positive electrode 114, and separator 113, a battery case 120, and a sealing member 140 sealing the battery case 120. The rechargeable lithium battery 100 is manufactured by sequentially stacking the negative electrode 112, separator 113, positive electrode 114, and spiral-winding them and housing the wound resultant in the battery case 120.

Hereinafter, the disclosure is illustrated in more detail with reference to examples and comparative examples. However, these examples are exemplary, and the present disclosure is not limited thereto.

Furthermore, what is not described in this disclosure may be sufficiently understood by those who have knowledge in this field and will not be illustrated here.

### EXAMPLES

### Preparation of Negative Active Material for Rechargeable Lithium Battery

### Preparation Example 1

SiOₓ (0≦x<2) powder having an average particle diameter of 50 nm and cobalt (Co) having an average particle diameter of 5 nm were put in a pot in a weight ratio of 1:0.1 to 1:1. (SiOₓ:Co=1:0.1 to 1:1 weight ratio)

Subsequently, cobalt was deposited on the surface of the SiOₓ using an e-beam deposition method.

Subsequently, the cobalt-coated SiOₓ powder was five times washed with an excessive amount of water to remove cobalt not coated on the SiOₓ powder and impurities. Subsequently, the washed SiOₓ powder was filtered by using a filter made of a polypropylene (PP) material, dried at a temperature of 100° C. to 250° C. for 6 hours under a vacuum, obtaining SiOₓ powder deposited with cobalt having an average particle diameter of 5 nm. Then, the cobalt-deposited SiOₓ powder was used as a negative active material for a rechargeable lithium battery.

### Comparative Preparation Example 1

SiOₓ powder having an average particle diameter of 50 nm was used as a negative active material for a rechargeable lithium battery.

### Preparation of Negative Active Material for Rechargeable Lithium Battery

### Example 1

The negative active material for a rechargeable lithium battery prepared according to Preparation Example 1, Super P carbon black, and polyvinylidene fluoride (PVdF) in a weight ratio of 80:10:10 were mixed in an N-methyl pyrrolidone solvent to providenegative active material slurry. The negative active material slurry was coated on a 50 μm-thick copper foil, vacuum-dried at 150° C. for 20 minutes, and roll-pressed, manufacturing a negative electrode. The negative active material was loaded in an amount of 9 mg/cm², and the negative electrode had a current density of 1.62 mA/cm² at a 0.2 C charging.

The negative electrode, a lithium foil as a counter electrode, a microporous polyethylene film (Hipore, thickness: 16 μm, Asahi Kasei E-materials Corporation Tokyo, Japan) as a separator, and a electrolyte solution prepared by dissolving LiPF₆ in 1 M of a concentration in a mixed solvent prepared by mixing ethylene carbonate and dimethyl carbonate in a volume ratio of 50:50 were used in a well-known manufacturing process, manufacturing a half coin cell (2016 R-type half cell).

### Comparative Example 1

A half coin cell was manufactured according to the same method as Example 1 except for using the negative active material prepared according to the Comparative Preparation Example 1 instead of the negative active material made according to Preparation Example 1.

### EVALUATION

### Evaluation 1: Cycle-Life Characteristics

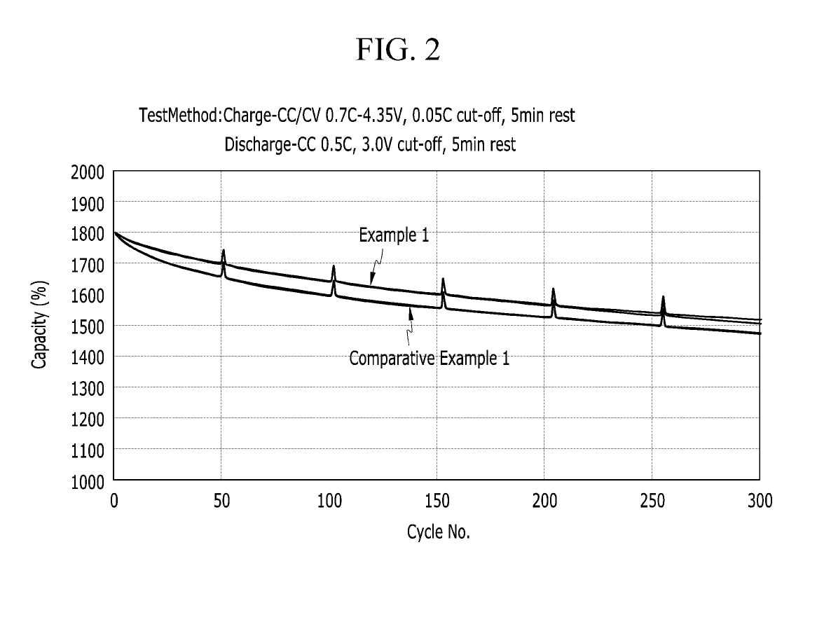

Cycle-life characteristics of the two half coin cells according to Example 1 and the two half coin cells according to Comparative Example 1 were evaluated, and the results are provided in FIG. 2.

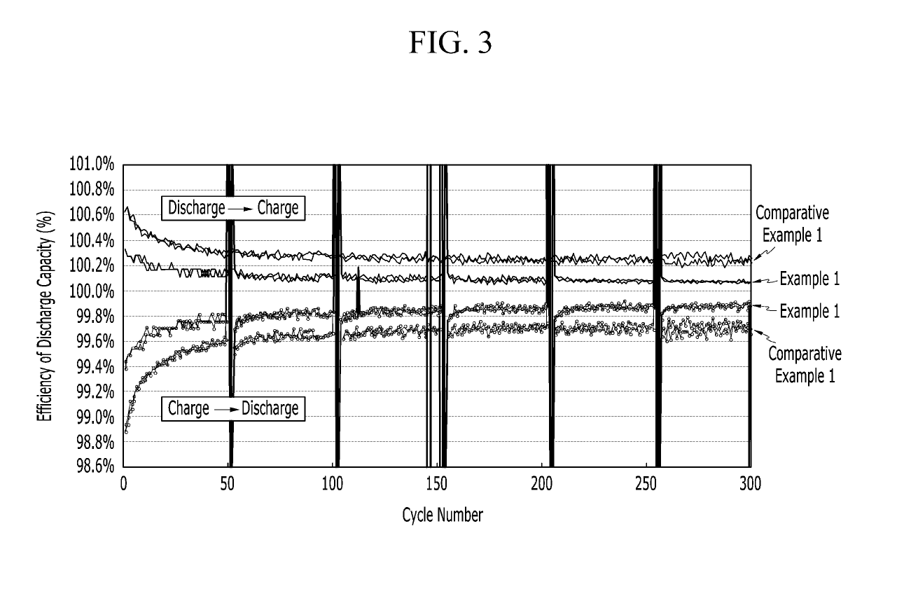

Referring to FIG. 2, the half coin cell using a transition metal catalyst prepared according to Example 1 showed excellent cycle-life characteristics compared with the half coin cell using no catalyst made according to Comparative Example 1. The test results for this evaluation are set forth in the FIGS. 2 and 3.

### Evaluation 2: Capacity Efficiency

Cycle-life characteristics of the half coin cells according to Example 1 and Comparative Example 1 were evaluated, and the results are provided in FIG. 3.

Referring to FIG. 3, the half coin cell using a transition metal catalyst according to Example 1 showed excellent negative electrode efficiency compared with the half coin cell using no catalyst made according to Comparative Example 1. The test results for this evaluation are set forth in the FIGS. 2 and 3.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of preparing a negative active material for a rechargeable lithium battery, comprising
preparing a powder comprising a silicon-carbon composite or a Si-based material represented by Chemical Formula 1
SiOₓ (Chemical Formula 1)
wherein 0≦x<2; and
introducing a transition metal-containing material including a transition metal or a transition metal oxide catalyst, in a form of an island, on a surface of the powder:

2. The method of claim 1, wherein the transition metal is selected from the group consisting of gold (Au), silver (Ag), platinum (Pt), cobalt (Co), manganese (Mn), nickel (Ni), vanadium (V), iron (Fe), copper (Cu), scandium (Sc), zirconium (Zr), niobium (Nb), chromium (Cr), molybdenum (Mo), or a combination thereof.

3. The method of claim 1, wherein the transition metal-containing material has an average particle diameter in the range of about 0.5 nm to about 20 nm.

4. The method of claim 1, wherein the transition metal-containing material has an average particle diameter in the range of about 0.5 nm to about 10 nm.

5. The method of claim 1, wherein the transition metal-containing material is included in an amount of about 1 part to about 100 parts by weight based on 100 parts by weight of the Si-based material or 100 parts by weight of the silicon-carbon composite.

6. The method of claim 1, wherein the Si-based material has an average particle diameter in the range of about 0.5 nm to about 100 nm.

7. The method of claim 1, wherein the process of introducing the transition metal-containing material in the form of an island, on the surface of the powder of the Si-based material is performed using a physical vapor deposition method, a chemical vapor deposition method, a thermal deposition method, an electron beam evaporation method, a sputtering method, or a combination thereof.

8. A negative active material for a rechargeable lithium battery, comprising
a core comprising a silicon-carbon composite or a Si-based material represented by Chemical Formula 1:
SiOₓ (Chemical Formula 1)
wherein 0≦x<2; and
a transition metal-containing material, in a form of an island, on the surface of the core.

9. The negative active material of claim 8, wherein the transition metal-containing material is represented by Chemical Formula 2 or 3:
M_{y}O_{z} [Chemical Formula 2]
M [Chemical Formula 3]
wherein M is a metal comprising gold (Au), silver (Ag), platinum (Pt), cobalt (Co), manganese (Mn), nickel (Ni), vanadium (V), iron (Fe), copper (Cu), scandium (Sc), zirconium (Zr), niobium (Nb), chromium (Cr), molybdenum (Mo), or a combination thereof, wherein 0<y<5, and wherein 0<z<20.

10. The negative active material of claim 8, wherein the transition metal-containing material has an average particle diameter in the range of about 0.5 nm to about 20 nm.

11. The negative active material of claim 8, wherein the transition metal-containing material has an average particle diameter in the range of about 0.5 nm to about 10 nm.

12. The negative active material of claim 8, wherein the transition metal-containing material is included in an amount of about 1 part to about 100 parts by weight based on 100 parts by weight of the Si-based material or 100 parts by weight of the silicon-carbon composite.

13. The negative active material of claim 8, wherein the Si-based material has an average particle diameter of about 0.5 nm to about 100 nm.

14. A rechargeable lithium battery comprising:
a negative electrode comprising a negative active material prepared according to the method of preparing a negative active material for a rechargeable lithium battery of claim 1;
a positive electrode including a positive active material; and
an electrolyte.

15. The battery of claim 14, wherein the negative active material includes a core and a transition metal-containing material, in a form of an island, on the surface of the core, and the core comprises a silicon-carbon composite or a Si-based material represented by Chemical Formula 1:
SiOₓ (Chemical Formula 1)
wherein 0≦x<2; and
a transition metal-containing material, in a form of an island, on the surface of the core.

16. The battery of claim 14, wherein the transition metal-containing material is represented by Chemical Formula 2 or 3:
MyOz (Chemical Formula 2)
M (Chemical Formula 3)
wherein M is a metal comprising gold (Au), silver (Ag), platinum (Pt), cobalt (Co), manganese (Mn), nickel (Ni), vanadium (V), iron (Fe), copper (Cu), scandium (Sc), zirconium (Zr), niobium (Nb), chromium (Cr), molybdenum (Mo), or a combination thereof, wherein 0<y<5, and wherein 0<z<20.

17. The battery of claim 14, wherein the transition metal-containing material has an average particle diameter in the range of about 0.5 nm to about 20 nm.

18. The battery of claim 14, wherein the transition metal-containing material has an average particle diameter in the range of about 0.5 nm to about 10 nm.

19. The battery of claim 14, wherein the transition metal-containing material is included in an amount of about 1 part to about 100 parts by weight based on 100 parts by weight of the Si-based material or 100 parts by weight of the silicon-carbon composite.

20. The battery of claim 14, wherein the Si-based material has an average particle diameter of about 0.5 nm to about 100 nm.
